(19) United States
(12) Patent Application Publication
(10) Pub. No.: US 2012/0111276 A1
(43) Pub. Date: May 10, 2012

(54) COOLING PET BED

(75) Inventors: Kenneth M. Leahy, Atlanta, GA (US); Mark H. Raeside, Atlanta, GA (US)

(73) Assignee: LAYRAY, LLC, Atlanta, GA (US)

(21) Appl. No.: 12/939,232

(22) Filed: Nov. 4, 2010

(51) Int. Cl. A01K 29/00

(52) U.S. Cl. 119/28.5

(57) ABSTRACT

A thermodynamically cooled portable pet bed consisting of an insulated molded base, a planer top made from a conductive metal with wicking chambers welded to its undersurface, and pre-frozen, re-usable pods containing a non toxic liquid that is housed in either a similar conductive metal or a durable membrane that will hold its shape and efficiently transfer the frozen temperature to the wicking chambers and up to the surface above. Once the pods are inserted into the wicking chambers, and the top is closed into the insulated base, the above components create several hours of an efficiently cooled surface for the animal to enjoy without any human intervention.

### BACKGROUND OF THE INVENTION

1. Field of the Invention

This invention is an advancement in pet cooling products, and, more particularly, is a cooling platform for the purpose of keeping animals such as canines and cats cool when subjected to uncomfortably high temperatures both outdoors and indoors.

2. Description of Related Art

While there are countless pet beds in existence, the field of temperature regulating beds is limited. Possibly the least technically advanced method, but also the most well known, is to simply provide a bag of ice for the pet to lie on or near. Various examples of cooling pet beds are evidenced in the prior art. U.S. Pat. No. 4,064,835, discloses an air-conditioned pet bed wherein a portable unit is provided with an insulated bottom portion containing re-usable, pre-frozen, chemical ice-packs and a top portion which fits over the bottom portion and has a planar, perforated surface to provide an area for a pet to recline and prevent direct contact with the ice-packs, thereby providing cooling of the pet through the perforations in the top portion. U.S. Pat. No 4,899,693, discloses a cooled portable pet bed has an insulated base with a central recess dimensioned to receive a container having a sealable opening for the insertion of ice cubes. An open weave fabric mattress covers the upper surface of the container to form a cooled mattress for a pet. A removable carrying strap allows the container to be utilized as a canteen for drinking water. The container may be formed from a rigid or durable flexible material. U.S. Pat. No. 6,553,935, discloses a pet air bed that includes a plastic housing having a base portion and an elevated pet support portion connected by a hinge to the base portion and having a number of air flow holes provided through pet support and/or pet adjacent surfaces thereof; a fan assembly being connected to the plastic housing in a manner such that air flow from the exterior of the plastic housing is generated into a cavity within the plastic housing in a manner to cause air to flow out through the air flow holes in the elevated pet support portion; the cavity formed within the plastic housing is provided for positioning cooling or heating elements such that the pet may have a temperature controlled pet bed; a forward section of the plastic housing including clips for holding a name tag or other pet identifying type of plate.

While the above prior art all share the same intent of cooling a pet, none of them demonstrate the unique thermodynamic quality of this device. The '835 patent is less desirable in that it relies on cooled air from chemical ice packs to rise through a perforated surface. While the animal's body heat might fall through the perforated surface, the cooled air would fall and not rise to create the intended “air conditioned” feel of the bed. The '693 patent is significantly dissimilar in that it requires the animal to lie directly on the cooling source. Because the cooling surface also doubles as a canteen for human and animal consumption, it is clear that the art would have to be limited in size and would only accommodate the smallest of animals. A medium sized dog would require a large “cooling canteen” that would require several pounds of ice that would then have to be inserted into the chamber. This process is unrealistic and very inefficient. The '935 patent, while arguably functional, shares only the fact that his art is a cooling pet bed. The '935 patent is based on an electric fan blowing heated or cooled air onto the animal with no explanation of the heating/cooling element.

Based on the prior art discussed above, it is clear that there have been attempts to satisfy the ongoing need of keeping an animal safe and cool when subjected to environments with uncomfortably high temperatures. It is also clear, that because today's current market lacks any product similar to the '835 and '693 patents mentioned above; their devices did not sufficiently satisfy this need. It should be appreciated that this invention has been tested and solves the problem efficiently, economically and with relatively no human interaction.

### BRIEF SUMMARY OF THE INVENTION

This invention represents advancement in the area of pet beds, specifically pet beds designed to provide a cool resting spot. The pet bed transfers cold temperatures from a cooling substance contained in the base of the invention to the surface/top comprised of a conductive material whereupon the pet may rest. In taking into consideration the previously discussed inherent disadvantages in the known prior art, the present invention is a significant advancement in a pet cooling bed. By using thermodynamics, this device wicks a small, insulated, cooling source to and evenly across a conductive platform for the animal to enjoy. This bed solves the immediate need of a pet owner in providing a cool, safe and comfortable environment for pets without any of the disadvantages previously noted. The true nature and function of the current art is more specifically detail below and with subsequent illustrations.

The current invention consists of three elements: A low profile, insulated, molded base that could be made from, but not limited, a rigid plastic or resin material consisting of voids for the wicks and cooling pods to remain insulated. A non-slip platform consisting of a conductive metal like, but not limited to, aluminum with wicks made from the same material welded to the undersurface of the platform. In the current art the conductive surface consists of powder coated aluminum and functions extremely well, however it should be clear that any material with the similar conductive properties of aluminum could be used. Cooling pods designed to fit within the exact shape of the aforementioned wicks in the platform, consisting of containers filled with a non-toxic liquid that can be frozen in a residential freezer. The pods can be made from a similar conductive material as the platform or any thin, durable material that could be re-frozen and hold its shape and easily transfer the frozen temperatures through its surface to the wicking chambers. As previously noted in the abstract, once the pods are inserted into the wicking chambers, and the top is closed into the insulated base, the above components create several hours of an efficiently cooled surface for the animal to enjoy without any human intervention.

The invention is, in its most basic terms, as one skilled in the art will recognize, a mechanism for thermodynamically cooling conductive surface through a temperature transfer from a cooled substance to the surface. The embodiments described herein are not the sole mechanisms for achieving the goals of the invention. The features described in the claims, as well as the language used throughout the specification, are not to be considered as limiting, but as including equivalent mechanisms within the scope of the present invention.

It is the intent of the current art to provide a new and improved cooling dog bed that specifically uses thermodynamics, and shares only its intent and a few similar components with its predecessors.

It is also the intent of the current art to provide a device that can efficiently cool an animal for many hours by simply inserting the required frozen pods and thus requiring no further human interaction.

It is further the intent of the current art to provide an economical, yet well constructed, product that is easily portable and efficient enough to only require a limited amount of cooling pods that can be frozen daily in a residential freezer.

The current art intends for the voids in the base to be completely waterproof in order to accommodate any condensation or melted water if the owner decides to use ice in lieu of the aforementioned pods. It should be noted that the voids in the base would have plugged drain holes that, when opened would easily eliminate any water or could even provide drinking water for the animal is so desired.

The current art is also intended to be fully functional at a variety of sizes that would comfortably accommodate various sized animals. The designs would be the same; however the size and amount of necessary pods and voids would vary in order to efficiently cool the different sized beds.

The current art further intends to be designed to accommodate various accessories that may improve the current product. Some of which may be, but are in no way limited to, removable slip covers for the platform that would not impede the cooling effect of the conductive top, molded base protectors that could be produced in a variety of designs to personalize the current art and clip on water dishes to take advantage of melting drinking water if ice is being used in lieu of the aforementioned pods.

The details described thus far, along with various more specific design elements of the current art can be more fully understood with the accompanied drawings and more precisely described within the preferred embodiment of the invention.

### BRIEF DESCRIPTION OF THE DRAWINGS

FIG. 1 is a front perspective view of the cooling pet bed with a pet resting on the top conductive platform.

FIG. 2 shows an interior and partial exterior view of the cooling pet bed wherein wicking chambers are used to transfer cold temperatures to the top conductive platform.

FIG. 3 is a side view of the cooling pet bed showing the rear pivot point.

FIG. 4 shows an interior and partial exterior view of the cooling pet bed wherein wicking flanges are used to transfer cold temperatures to the top conductive platform.

FIG. 5 depicts the movement of colder temperatures from the wicking chambers or wicking flanges to the platform.

### REFERENCE NUMBERS IN DRAWINGS

1 Insulated Base
2 Voids
3 Wicking Chambers
4 Cooling Pods
5 Top Conductive Platform
6 Rear Pivot Point
7 Wicking Flanges
8 Molded Cooling Pods

### DETAILED DESCRIPTION OF THE INVENTION

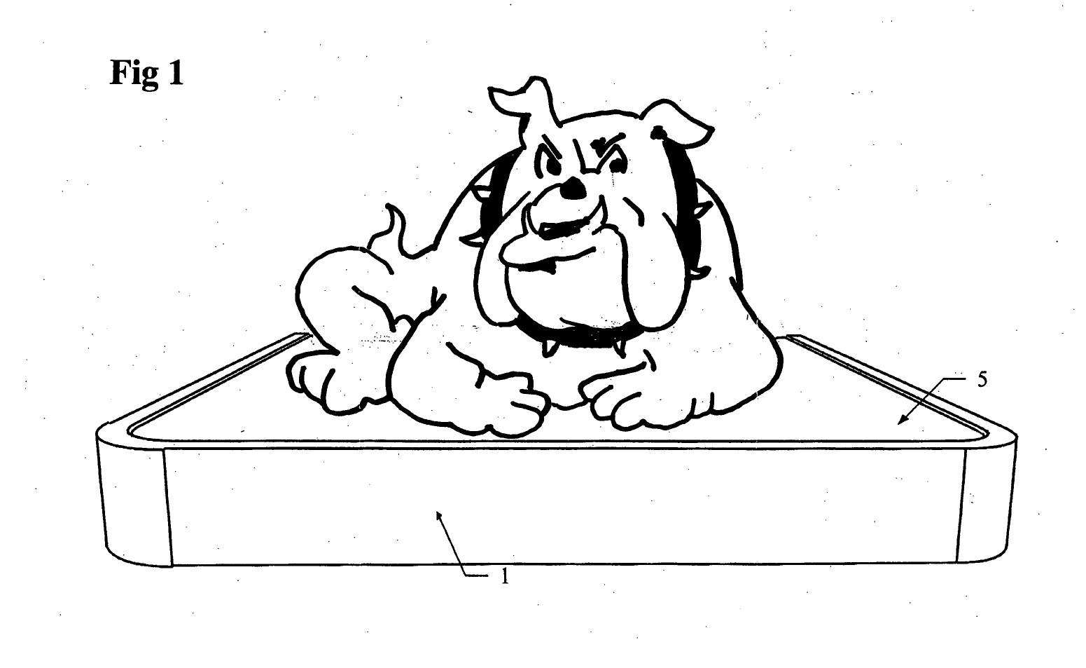

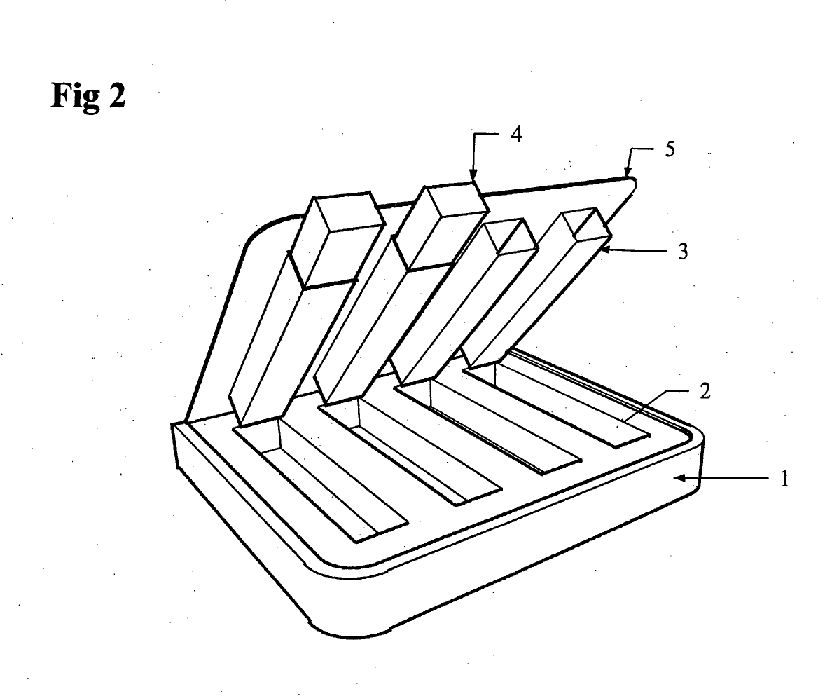

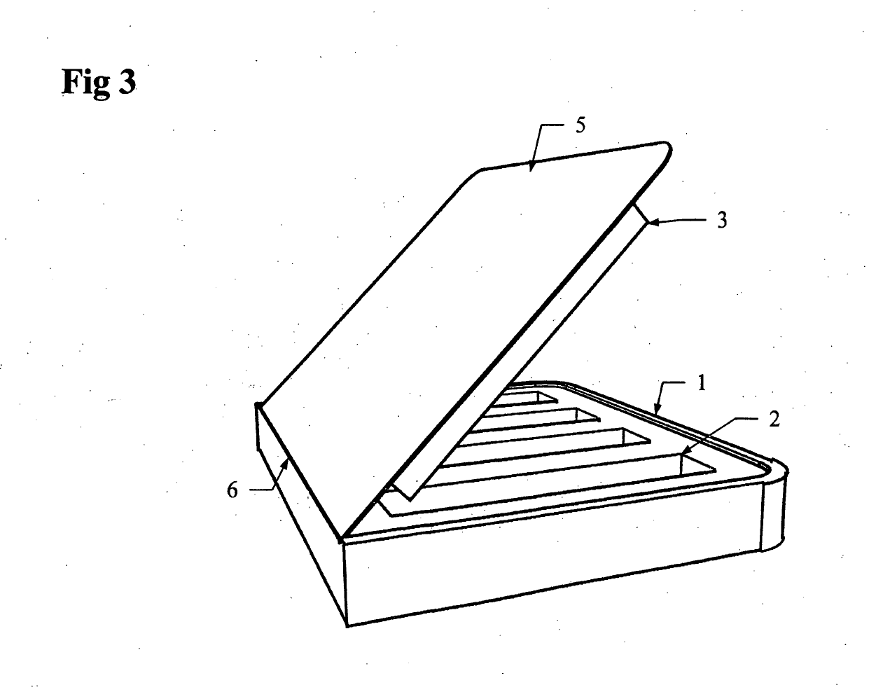

Depicted in FIG. 1 is a representation of a pet resting atop the cooling pet bed, showing generally the insulated base (1) and the top conductive platform (5). FIG. 2 shows a side front perspective of the preferred embodiment of the invention, more specifically disclosing the top conductive platform (5) rotating on an axis attached to the rear of the base (1). Also shown are the voids (2) present in the insulated base (1) used to house and insulate the wicking chambers (3) and cooling pods (4) when the platform (5) is closed. The illustration also shows how the wicking chambers (3), being fully boxed with an open end could receive ice in either block or cube form if the user chooses to not use the provided cooling pods (4). FIG. 3 shows a rear/side perspective of the preferred embodiment of the invention, more specifically disclosing the rear pivot point (6) joining the platform (5) and the insulated base (1). FIG. 3 further shows an additional view of the voids (2) contained in the insulated base (1) as well as demonstrating that the platform (5) fits into the molded edge of the insulated base (1).

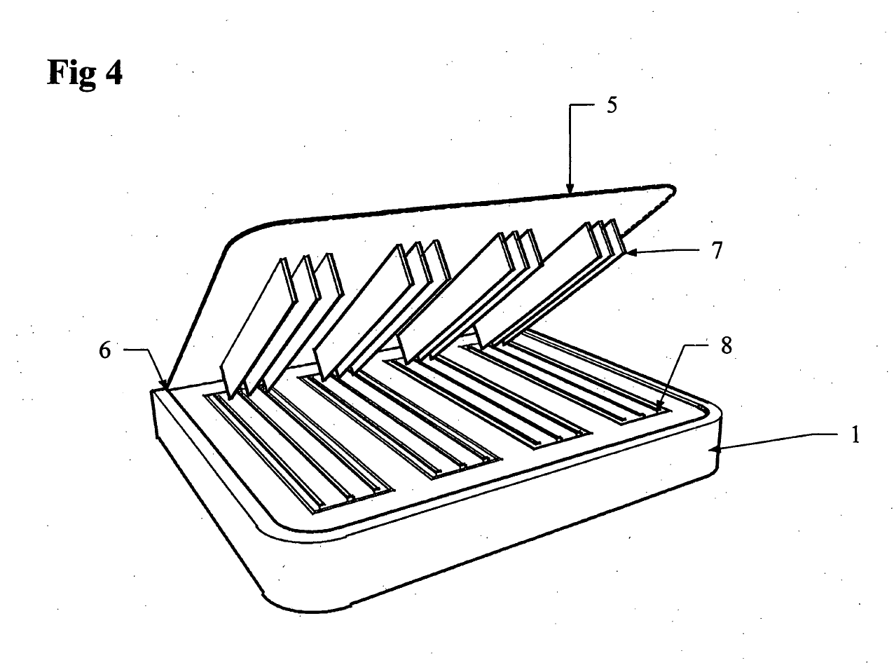

FIG. 4 shows a front perspective view of an alternative embodiment of the intended thermodynamic qualities of the invention. In lieu of wicking chambers (3), wicking flanges (7) are welded to the platform (5) and would descend into molded cooling pods (8) designed with voids to accommodate the flanges (7) that are inserted into the insulated base (1).

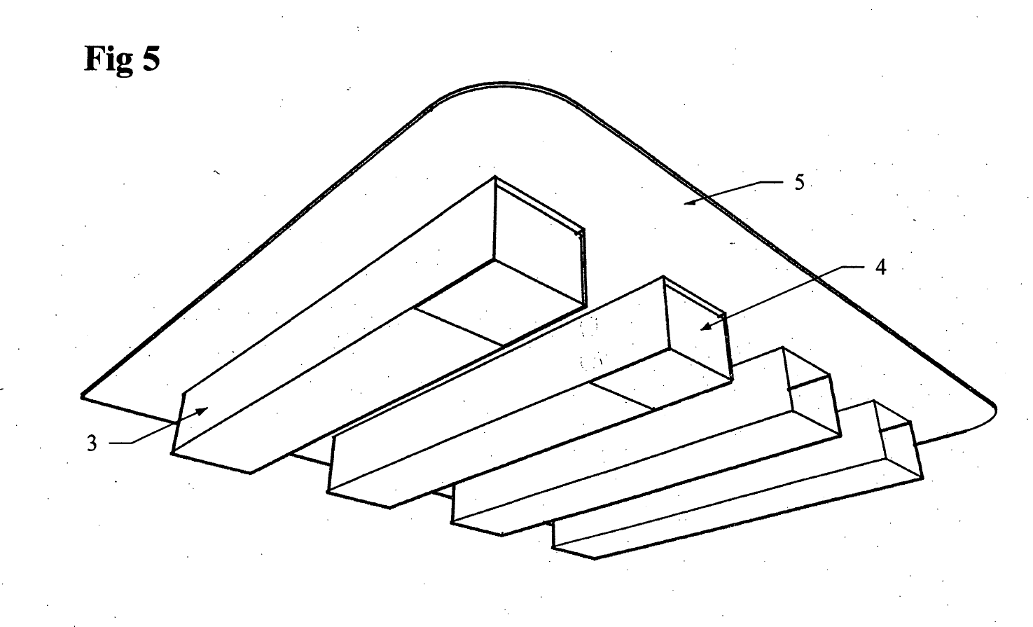

FIG. 5 shows a perspective from below the platform (5) demonstrating how the wicking chambers (3) are attached to the undersurface of the platform (5), and thus creating a pocket for the cooling pods (4) to be inserted. As shown with the arrows on the illustration, the cold temperatures from the pods (4) are absorbed into the bottom surface of the wicking chambers (3) and radiated up the sides and into and throughout the entire platform (5).

We claim:

1. A cooling pet bed consisting of:
an insulated base,
said insulated base being container made from a moldable material the walls of which are filled with an insulating substance, having voids at regular intervals each surrounded by insulated walls,
a platform,
said platform being a flat conductive surface with hollow wicking chambers, open at the forward edge, capable of accepting a cooling substance, through the introduction of cooling pods, affixed to the underside ,

2. The cooling pet bed of claim 1 wherein the platform attaches to the base by means of a rear pivot point.

3. The cooling pet bed of claim 1 wherein the platform is a flat conductive surface with descending wicking flanges affixed to the underside,

4. The cooling pet bed of claim 3 in which the voids contained in the insulated base are comprised of a cooling substance containing voids sized to accept the wicking flanges.
